(19) United States
(12) Patent Application Publication
(10) Pub. No.: US 2007/0116980 A1
(43) Pub. Date: May 24, 2007

(54) Metallic protective layer

(76) Inventors: Friedhelm Schmitz, Dinslaken (DE); Kai Wieghardt, Bochum (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/582,149

(22) PCT Filed: Dec. 1, 2004
(86) PCT No.: PCT/EP04/13661

§ 371 Date: Jun. 8, 2006

(30) Foreign Application Priority Data
Dec. 11, 2003 (EP) 03028577.9

(51) Int. Cl. B32B 15/20

(52) U.S. Cl. 428/681; 428/676; 428/678

(57) ABSTRACT

The invention relates to a metal protective coating which protects against corrosion and oxidation, in particular for components in turbines, said components being used at high temperatures. The advantageous composition is as follows: 11.5 20.0 wt % chrome, 0.3 1.5 wt % silicone, 0.0 1.0 wt % aluminium, 0,0-0.7 wt % yttrium and/or at least one metal from the group comprising Sc and rare earth elements, and the remainder being iron and production-related impurities.

### CROSS REFERENCE TO RELATED APPLICATIONS

This application is the US National Stage of International Application No. PCT/EP2004/013661, filed Dec. 1, 2004 and claims the benefit thereof. The International Application claims the benefits of European Patent application No. 03028577.9 filed Dec. 11, 2003. All of the applications are incorporated by reference herein in their entirety.

### FIELD OF THE INVENTION

The invention relates to a metallic protective layer as described in the claims and a layer system as described in the claims.

### BACKGROUND OF THE INVENTION

Metallic protective layers for protecting a component, in particular a component which consists of a superalloy based on iron, nickel or cobalt, against corrosion and oxidation in particular at high temperatures, with the component, in particular a component of a steam or gas turbine, being exposed to a flue gas or the like at a high temperature, are generally known.

Most of these protective layers are known under the collective name MCrAlX, where M represents at least one of the elements selected from the group consisting of iron, cobalt and nickel and further essential constituents are chromium, aluminum and X=yttrium, although the latter may also be partially or entirely replaced by an equivalent element selected from the group consisting of scandium and the rare earth elements.

Typical coatings of this type are known from U.S. Pat. Nos. 4,005,989 and 4,034,142. Moreover, it is known from the latter patent that an additional silicon content can further improve the properties of protective layers of the type described above.

Furthermore, EP-A 0 194 392 has disclosed numerous special compositions for protective layers with admixtures of further elements for various applications. In this context, the element rhenium as an admixture forming up to 10% by weight, as well as many other elements that can optionally be added, is mentioned. In view of the lack of more specific further ranges for possible admixtures, however, none of the protective layers indicated is qualified for special conditions, such as for example on rotor blades and guide vanes of steam or gas turbines with high inlet temperatures which have to be operated for prolonged periods of time.

Protective layers which contain rhenium are also known from U.S. Pat. No. 5,154,885, EP-A 0 412 397, DE 694 01 260 T2 and WO 91/02108 A1. The overall disclosure revealed by these documents is incorporated in its entirety in the present disclosure.

EP 0 253 754 91 reveals embodiments for applying a protective layer to a gas turbine component that is to be exposed to high thermal stresses.

Efforts to increase the inlet temperatures of both stationary steam and gas turbines and aircraft engines are of considerable significance in the specialist field of gas turbines, since the inlet temperatures are important variables in determining the thermodynamic efficiencies which can be achieved by gas turbines. The use of specially developed alloys as base materials for components which are to be exposed to high thermal stresses, such as guide vanes and rotor blades, in particular the use of single-crystal superalloys, allows inlet temperatures of well over 1000° C. Nowadays, the state of the art allows inlet temperatures of 950° C. and more in the case of stationary gas turbines and 1100° C. and more in gas turbines of aircraft engines.

Examples of the structure of a turbine blade or vane with a single-crystal substrate, which for its part may be of complex construction, are disclosed by WO 91/01433 A1.

Whereas the physical load-bearing capacity of the by now highly developed base materials for the highly stressed components is substantially free of problems with regard to possible future increases in the inlet temperatures, to achieve a sufficient resistance to oxidation and corrosion it is necessary to employ protective layers. In addition to a protective layer being sufficiently chemically stable under the attacks expected from flue gases at temperatures of the order of 1000° C., a protective layer must also have sufficiently good mechanical properties, not least with regard to the mechanical interaction between the protective layer and the base material. In particular, the protective layer must be sufficiently ductile to be able to follow any deformation of the base material and not to crack, since this can give rise to points of attack for oxidation and corrosion. This typically presents the problem that increasing the levels of elements such as aluminum and chromium, which are able to improve the resistance of a protective layer to oxidation and corrosion, leads to a deterioration in the ductility of the protective layer, with the result that mechanical failure, in particular the formation of cracks, is likely under the mechanical stresses which customarily occur in a gas turbine. Examples of the ductility of the protective layer being reduced by the elements chromium and aluminum are known from the prior art.

### SUMMARY OF THE INVENTION

Accordingly, the invention is based on the object of providing a protective layer and a layer system which have a good high-temperature stability in corrosion and oxidation, a good long-term stability and, moreover, are especially well matched to mechanical stresses which are expected in particular in a steam or gas turbine at high temperature.

To achieve this object, the invention provides a protective layer and a layer system comprising this protective layer for protecting a component against corrosion and oxidation at a high temperature, which substantially comprises the following elements (details of amounts in percent by weight):
11.5 to 20.0 wt % chromium,
0.3 to 1.5 wt % silicon,
to 1.0 wt % aluminum,
to 0.7 wt % yttrium and/or at least one metal selected from the group consisting of scandium and the rare earth elements,
   remainder iron and production-related impurities.

In particular, the metallic protective layer consists of
12.5 to 14.0 wt % chromium,
0.5 to 1.0 wt % silicon,
0.0 to 0.5 wt % aluminum,
0.0 to 0.7 wt % yttrium and/or at least one metal selected from the group consisting of scandium and the rare earth elements,
   remainder iron and production-related impurities.

### BRIEF DESCRIPTION OF THE DRAWINGS

The invention is explained in more detail in the figures, in which:
FIGS. 1, 2 show examples of arrangements of the protective layer,
FIG. 3 shows a gas turbine,
FIG. 4 shows a combustion chamber, and
FIG. 5 shows a steam turbine.

### DETAILED DESCRIPTION OF THE INVENTION

FIG. 1 shows an example of an arrangement of a metallic protective layer 7 of a layer system 1.

The metallic protective layer 7 is arranged on a substrate 4 and in this case forms the outer layer of the layer system 1.

In FIG. 2, the metallic protective layer 7 constitutes an intermediate layer in the layer system 1.

The metallic protective layer 7 is likewise arranged on a substrate 4, but a further, for example ceramic layer 10 is also present on the metallic protective layer 7.

The protective layer 7 described also acts, for example, as a bonding layer for improving the bonding of the layer 10 to the substrate 4.

Other or further metallic and/or ceramic layers may be present.

In particular an aluminum oxide layer may be applied to or produced on this layer 7.

The ceramic layer 10 is in particular a thermal barrier coating based on zirconium oxide. This may be partially or fully stabilized zirconium oxide. Further ceramic materials for the ceramic thermal barrier coating 10 are conceivable.

Likewise conceivable are all coating processes for applying the metallic protective layer 7 and/or the ceramic layer 10 to the substrate 4 or to the metallic protective layer 7.

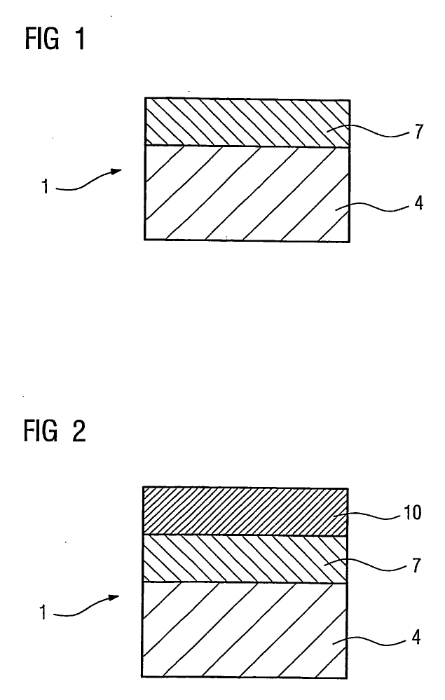

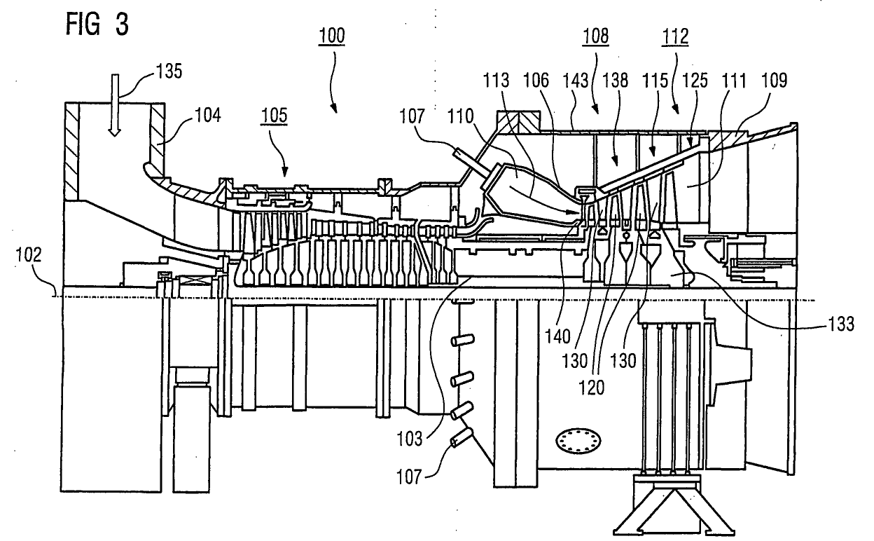

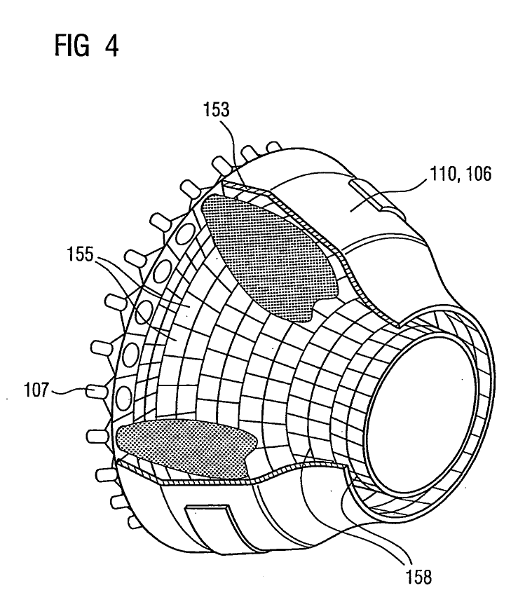

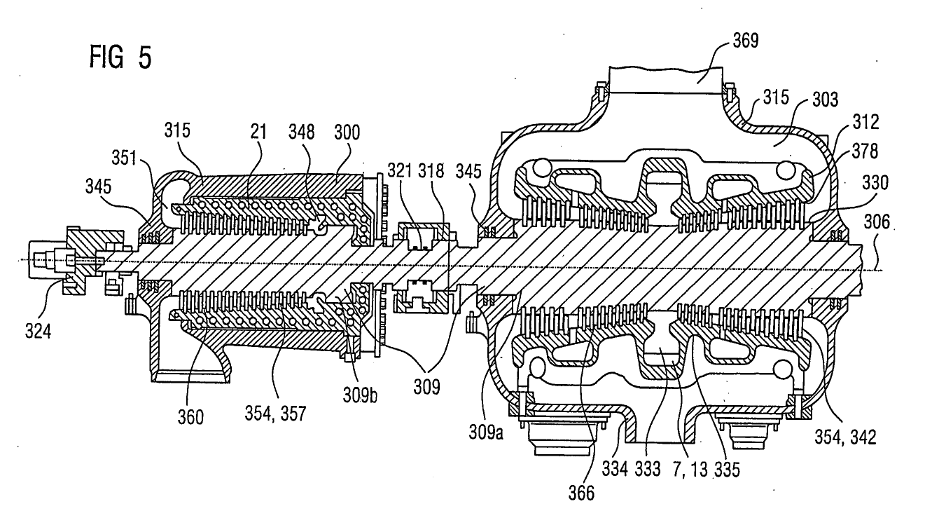

As has already been explained above, layer systems 1 of this type can be used for components in a gas turbine 100 (FIG. 3) and in a steam turbine 300, 303 (FIG. 5) or aircraft turbine.

The layer systems 1 can be used for newly produced components or refurbished components.

Highly stressed components, in particular turbine blades or vanes 354, 357, 366 (FIG. 5), 120, 130 (FIG. 3) are in many cases refurbished after use by the outer layers 7, 10 as well as further corrosion or oxidation layers being removed. The component (substrate 4) is also inspected for cracks, which are repaired if appropriate.

The component (substrate 4) can then again be provided with a metallic protective layer 7 in order to form a layer system 1.

The protective layer 7 combines a good resistance to corrosion with a particularly high stability with respect to oxidation and is also distinguished by particularly good ductility properties, making it especially well qualified for use in a steam turbine in particular in the event of a further increase in the inlet temperature.

The composition of the protective layer 7 based on iron has particularly good properties; in particular, the protective layer 7 can be very successfully applied to ferritic substrates 4.

In this case, the coefficients of thermal expansion a of substrate 4 and protective layer 7 can be very well matched, i.e. differences of up to 10% are possible, or are identical, so that there is no thermally induced build-up of stresses between substrate 4 and protective layer 7 (thermal mismatch), which could cause the protective layer 7 to flake off.

Identical coefficients of thermal expansion means that the differences are at most such that no thermally induced stresses occur at the temperatures of use.

This is particularly important since in the case of ferritic materials being used for the substrate 4, it is often the case that there is no heat treatment carried out for the diffusion bonding of the layer 7 to the substrate 4, since the ferritic substrate 4 has undergone a final heat treatment and should not be exposed to any further heat treatment close to or above the temperature of the final heat treatment (tempering treatment).

The protective layer 7 is particularly suitable for protecting a ferritic component against corrosion and oxidation at temperatures of up to 800° C., in particular up to 650° C.

The protective layer 7 bonds to the substrate 4 mostly or exclusively through adhesion.

The thickness of the protective layer 7 on the component 1 is preferably set to between approximately 100 μm and 300 μm.

The protective layer 7 is also particularly suitable for protecting a component against corrosion and oxidation while the component is exposed to a flue gas with the material at a temperature of around 950° C., or in the case of aircraft turbines even around 1100° C.

The protective layer 7 according to the invention is therefore particularly suitable for protecting a component of a steam turbine 300, 303 (FIG. 5) or gas turbine 100 (FIG. 3), in particular a guide vane 130, rotor blade 120 or other component (housing parts) which is exposed to hot steam or gas upstream or in the turbine part of the steam or gas turbine.

The substrate 4 may be metallic or ceramic.

In particular, the substrate 4 is a ferritic base alloy in the case of a steam turbine, a nickel-base or cobalt-base superalloy in the case of a gas turbine or a steel, in particular a 1% CrMoV steel or a 10% to 12% chromium steel.

Further advantageous ferritic substrates 4 for the layer system 1 may consist of:
1% to 2% Cr steel for shafts (309, FIG. 4):
such as for example 30CrMoNiV5-11 or 23CrMoNiWV8-8,
1% to 2% Cr steel for housings (for example 333, FIG. 4): G17CrMoV5-10 or G17CrMo9-10
10% Cr steel for shafts (309, FIG. 4):
X12CrMoWVNbN10-1-1
10% Cr steel for housings (for example 333, FIG. 4):
GX12CrMoWVNbN10-1-1 or GX12CrMoVNbN9-1.

Furthermore, the following composition is suitable as substrate 4 (details in percent by weight):
0.03 to 0.05% carbon
18 to 19% chromium
12 to 15% cobalt
3 to 6% molybdenum
1 to 1.5% tungsten
2 to 2.5% aluminum
3 to 5% titanium
   optionally small amounts of tantalum, niobium, boron and/or zirconium, remainder nickel.

Materials of this type are known as forging alloys under the names Udimet 520 and Udimet 720.

Alternatively, the following composition is suitable for the substrate 4 of the component 1 (details in percent by weight):
0 to 0.15% carbon
18 to 22% chromium
18 to 19% cobalt
0 to 2% tungsten
0 to 4% molybdenum
0 to 1.5% tantalum
0 to 1% niobium
1 to 3% aluminum
2 to 4% titanium
0 to 0.75% hafnium
   optionally small amounts of boron and/or zirconium, remainder nickel.

Compositions of this type are known as casting alloys under the names GTD222, IN939, IN6203 and Udimet 500.

Another alternative for the substrate 4 of the component 1 is the following composition (details in percent by weight):
0.07 to 0.1% carbon
12 to 16% chromium
8 to 10% cobalt
1.5 to 2% molybdenum
2.5 to 4% tungsten
1.5 to 5% tantalum
0 to 1% niobium
3 to 4% aluminum
3.5 to 5% titanium
0 to 0.1% zirconium
0 to 1% hafnium
   optionally a small amount of born, remainder nickel.

Compositions of this type are known as casting alloys PWA1483SX, IN738LC, GTD111, IN792CC and IN792DS; the material IN738LC is considered particularly preferred.

The following composition is considered a further alternative for the substrate 4 of the component 1 (details in percent by weight):
approximately 0.25% carbon
24 to 30% chromium
10 to 11% nickel
7 to 8% tungsten
0 to 4% tantalum
0 to 0.3% aluminum
0 to 0.3% titanium
0 to 0.6% zirconium

optionally a small amount of boron, remainder cobalt.

Compositions of this type are known as casting alloys under the names FSX414, X45, ECY768 and MAR-M-509.

FIG. 3 shows, by way of example, a partial longitudinal section through a gas turbine 100.

In the interior, the gas turbine 100 has a rotor 103 which is mounted such that it can rotate about an axis of rotation 102 and is also referred to as the turbine rotor. An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103. The annular combustion chamber 106 is in communication with a, for example, annular hot-gas passage 111, where, by way of example, four successive turbine stages 112 form the turbine 108. Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to the stator 143, whereas the rotor blades 120 of a row 125 are fitted to the rotor 103 by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 106, are subject to the highest thermal stresses. To be able to withstand the temperatures which prevail there, they have to be cooled by means of a coolant. The blades or vanes 120, 130 may also have above-described protective layers 7 protecting against corrosion (MCrAlX; M═Fe, Co, Ni, X═Y, rare earths) and heat (thermal barrier coating, for example ZrO₂, Y₂O₄-ZrO₂).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 4 shows a combustion chamber 110 of a gas turbine. The combustion chamber 110 is configured, for example, as what is known as an annular combustion chamber, in which a multiplicity of burners 102 arranged circumferentially around the turbine shaft 103 open out into a common combustion chamber space. For this purpose, the combustion chamber 110 overall is of annular configuration positioned around the turbine shaft 103.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155. On the working medium side, each heat shield element 155 is equipped with a particularly heat-resistant protective layer or is made from material that is able to withstand high temperatures. Moreover, on account of the high temperatures in the interior of the combustion chamber 110, a cooling system is provided for the heat shield elements 155 and/or for their holding elements.

The materials of the combustion chamber wall and their coatings may be similar to the turbine blades or vanes.

FIG. 5 illustrates, by way of example, a steam turbine 300, 303 with a turbine shaft 309 extending along an axis of rotation 306.

The steam turbine has a high-pressure part-turbine 300 and an intermediate-pressure part-turbine 303, each with an inner casing 312 and an outer casing 315 surrounding it. The high-pressure part-turbine 300 is, for example, of pot-type design. The intermediate-pressure part-turbine 303 is of two-flow design. It is also possible for the intermediate-pressure part-turbine 303 to be of single-flow design. Along the axis of rotation 306, a bearing 318 is arranged between the high-pressure part-turbine 300 and the intermediate-pressure part-turbine 303, the turbine shaft 309 having a bearing region 321 in the bearing 318. The turbine shaft 309 is mounted on a further bearing 324 next to the high-pressure part-turbine 300. In the region of this bearing 324, the high-pressure part-turbine 300 has a shaft seal 345. The turbine shaft 309 is sealed with respect to the outer casing 315 of the intermediate-pressure part-turbine 303 by two further shaft seals 345. Between a high-pressure steam inflow region 348 and a steam outlet region 351, the turbine shaft 309 in the high-pressure part-turbine 300 has the high-pressure rotor blading 354, 357. This high-pressure rotor blading 354, 357, together with the associated rotor blades (not shown in more detail), constitutes a first blading region 360. The intermediate-pressure part-turbine 303 has a central steam inflow region 333. Assigned to the steam inflow region 333, the turbine shaft 309 has a radially symmetrical shaft shield 363, a cover plate, on the one hand for dividing the flow of steam between the two flows of the intermediate-pressure part-turbine 303 and also for preventing direct contact between the hot steam and the turbine shaft 309. In the intermediate-pressure part-turbine 303, the turbine shaft 309 has a second blading region 366 comprising the intermediate-pressure rotor blades 354, 342. The hot steam flowing through the second blading region 366 flows out of the intermediate-pressure part-turbine 303 from an outflow connection piece 369 to a low-pressure part-turbine (not shown) which is connected downstream in terms of flow.

The turbine shaft 309 is composed of two turbine part-shafts 309a and 309b, which are fixedly connected to one another in the region of the bearing 318. The blades or vanes 354, 357, 366, shafts 309 or other housing parts 333 may have above-described protective layers 7, 10 protecting against corrosion (MCrAlX; M═Fe, X═Y, Si, rare earths) and heat (thermal barrier coating, for example ZrO₂, Y₂O₄-ZrO₂).

1. - 18. (canceled)

19. A metallic protective layer, comprising:
11.5 to 20.0% chromium (wt %);
0.3 to 1.5% silicon (wt %);
0.0 to 1.0% aluminum (wt %);
0.0 to 0.7% yttrium (wt %) or at least one metal selected from the group consisting of scandium and the rare earth elements; and
remainder iron and production-related impurities.

20. The metallic protective layer as claimed in claim 19, further comprising 0.0 to 0.7% yttrium (wt %) and at least one metal selected from the group consisting of scandium and the rare earth elements.

21. The metallic protective layer as claimed in claim 20, wherein the metallic protective layer comprises:
12.5 to 14.0% chromium;
0.5 to 1.0% silicon;
0.1 to 0.5% aluminum.

22. A layer system, comprising:
a metallic substrate; and
a metallic protective layer comprising:
11.5 to 20.0% chromium (wt %),
0.3 to 1.5% silicon (wt %),
0.0 to 1.0% aluminum (wt %),
0.0 to 0.7% yttrium (wt %) and-at least one metal selected from the group consisting of scandium and the rare earth elements, and
remainder iron and production-related impurities.

23. The layer system as claimed in claim 22, wherein the substrate is ceramic or an iron-base, nickel-base or cobalt-base superalloy.

24. The layer system as claimed in claim 23, wherein the metallic protective layer is ferritic.

25. The layer system as claimed in claim 24, wherein the metallic protective layer and the substrate are ferritic and the protective layer bonds to the substrate by adhesion.

26. The layer system as claimed in claim 25, wherein the layer system is not diffusion treated.

27. The layer system as claimed in claim 26, wherein the coefficients of thermal expansion of the ferritic protective layer and of the ferritic substrate are within 10% of each other.

28. The layer system as claimed in claims 27, wherein-the substrate is 1% CrMoV steel or a 10 to 12% chromium steel.

29. The layer system as claimed in claims 27, wherein the substrate is selected from the group consisting of: 30CrMoNiV5-11, 23CrMoNiWV8-8, G17CrMoV5-10, G17CrMo9-10, X12CrMoWVNbN10-1-1, GX12CrMoWVNbN10-1-1, and GX12CrMoVNbN9-1

30. The layer system as claimed in claim 29, wherein a zicronium oxide based thermal barrier coating is applied to the metallic protective layer to form a turbine component.

31. The layer system as claimed in claim 30, wherein the turbine component is selected from the group consisting of: a turbine blade, a turbine vane, a housing part, a region of a housing, and a combustion chamber lining.

32. The layer system as claimed in claim 31, wherein the protective layer thickness is between 100 μm and 300 μm.

33. The layer system as claimed in 32, wherein the layer system is suitable for exposure to a temperature of up to 950° C.

34. A high temperature gas turbine component, comprising:
a metallic or ceramic substrate; and
a metallic protective layer comprising:
11.5 to 20.0% chromium (wt %),
0.3 to 1.5% silicon (wt %),
0.0 to 1.0% aluminum (wt %),
0.0 to 0.7% yttrium (wt %) and at least one metal selected from the group consisting of scandium and the rare earth elements, and
remainder iron and impurities.

35. The component as claimed in claim 34, wherein the component substrate is a iron-based, nickel-based or cobalt-based super alloy.

36. The component as claimed in claim 35, wherein the component is selected from the group consisting of: a turbine blade, a turbine vane, a housing part, a region of a housing, and a combustion chamber lining.

37. The component as claimed in claim 36, wherein the metallic protective layer thickness is between 100 μm and 300 μm.

38. The component as claimed in claim 37, wherein the metallic protective layer comprises:
12.5 to 14.0% chromium;
0.5 to 1.0% silicon;
0.1 to 0.5% aluminum.
